(19) United States
(12) Patent Application Publication
(10) Pub. No.: US 2025/0015272 A1
(43) Pub. Date: Jan. 9, 2025

(54) SECONDARY BATTERY AND ELECTRONIC DEVICE

(71) Applicant: Ningde Amperex Technology Limited, Ningde (CN)

(72) Inventor: Bin WANG, Ningde (CN)

(73) Assignee: Ningde Amperex Technology Limited, Ningde (CN)

(21) Appl. No.: 18/764,210

(22) Filed: Jul. 4, 2024

(30) Foreign Application Priority Data
Jul. 5, 2023 (CN) 202310819668.8

(51) Int. Cl. H01M 4/36; H01M 4/02; H01M 4/583; H01M 4/62; H01M 10/0525

(52) U.S. Cl. CPC H01M 4/366; H01M 4/583; H01M 4/622; H01M 10/0525; H01M 2004/027

(57) ABSTRACT

A secondary battery includes a negative electrode plate. The negative electrode plate includes a negative current collector, a first active layer, and a second active layer. The first active layer is disposed between the negative current collector and the second active layer. In a thermogravimetric analysis, a weight loss rate of the first active layer in a temperature range of 350° C. to 500° C. is 1.3% to 3.0%, and a weight loss rate of the second active layer in a temperature range of 350° C. to 500° C. is 0.05% to 0.65%. Such settings can improve the kinetic performance of the secondary battery.

### CROSS-REFERENCE TO RELATED APPLICATION

This application is a continuation application of Chinese Application No. 202310819668.8, filed on Jul. 5, 2023, the contents of which are incorporated herein by reference in its entirety.

### TECHNICAL FIELD

This application relates to the field of electrochemical technology, and in particular, to a secondary battery and an electronic device.

### BACKGROUND

By virtue of a high energy storage density, a high open-circuit voltage, a low self-discharge rate, a long cycle life, high safety, and other advantages, secondary batteries (such as a lithium-ion battery) used as a new type of mobile energy storage device are widely used in various fields such as electrical energy storage, mobile electronic devices, electric vehicles, and aerospace equipment. With the continuous development of secondary batteries, users are seeking higher kinetic performance, including a shorter charging time and a higher charge rate. Therefore, how to improve the kinetic performance of a secondary battery becomes a pressing technical challenge to a person skilled in the art.

### SUMMARY

An objective of this application is to provide a secondary battery and an electronic device to improve the kinetic performance of the secondary battery.

It is hereby noted that in the description hereof, this application is construed by using a lithium-ion battery as an example of the secondary battery, but the secondary battery of this application is not limited to the lithium-ion battery. Specific technical solutions are as follows:

A first aspect of this application provides a secondary battery. The secondary battery includes a negative electrode plate. The negative electrode plate includes a negative current collector, a first active layer, and a second active layer. The first active layer is disposed between the negative current collector and the second active layer. In a thermogravimetric analysis, a weight loss rate of the first active layer in a temperature range of 350° C. to 500° C. is 1.3% to 3.0%, and a weight loss rate of the second active layer in a temperature range of 350° C. to 500° C. is 0.05% to 0.65%. In the negative electrode plate of this application, the bonding strength is relatively high between the first active layer and the negative current collector, and the content of the negative electrode binder in the second active layer is relatively low, thereby accelerating migration of lithium ions into the active material particles and into the active material layer. In this way, the probability of lithium ions being richly concentrated on the surface of the negative electrode plate is reduced, and in turn, the kinetic performance of the secondary battery is improved. For example, the charging time is shortened, the lithium plating is suppressed, and the cycle performance is improved. In addition, the relatively high bonding strength between the first active layer and the negative current collector enables the active material layer to be applied directly, that is, enables the first active layer and the second active layer to be applied directly without using an undercoat during production of the negative electrode plate, thereby reducing the thickness of the negative electrode plate and the volume of the secondary battery, and achieving a relatively high energy density.

In an embodiment of this application, the first active layer and the second active layer each include a negative electrode binder. The negative electrode binder includes a polymer formed by emulsion polymerization of styrene, acrylate ester, and acrylic acid. Based on a mass of the negative electrode binder, a mass percent of the styrene is 5% to 65%, a mass percent of the acrylate ester is 5% to 30%, and a mass percent of the acrylic acid is 5% to 65%. Used as a negative electrode binder, the polymer formed by emulsion polymerization of the styrene, acrylate ester, and acrylic acid added at a mass percent in the above ranges can improve the kinetic performance of the secondary battery, for example, shorten the charging time, suppress the lithium plating, and improve the cycle performance.

In an embodiment of this application, based on the mass of the negative electrode binder, a sum of the mass percentages of the styrene and the acrylate acid is 70% to 95%, and the mass percent of the acrylate ester is 5% to 30%. In an embodiment of this application, the sum of the mass percentages of the styrene and the acrylate acid is 70% to 90%, and the mass percent of the acrylate ester is 10% to 30%. Increasing the content of the acrylate ester appropriately can improve the toughness of the binder and ensure smooth processing. In addition, when the content of the acrylate ester is relatively low, the degree of swelling of the binder is lowered, and the kinetics are higher. If the content of the acrylate ester is overly low, the toughness of the binder is insufficient, thereby posing a risk of cracks during preparation of the electrode plate. If the content of the acrylate ester is relatively high, an ester group in the acrylate ester meets an ester group in an electrolyte solution to dissolve, so that the binder in the negative electrode plate is prone to swell during long-term use of the battery. Therefore, when used as a negative electrode binder, the polymer formed by emulsion polymerization of the styrene, acrylate ester, and acrylic acid added at a mass percent in the above ranges can improve the kinetic performance of the secondary battery, for example, shorten the charging time, suppress the lithium plating, and improve the cycle performance.

In an embodiment of this application, a weight-average molecular weight of the negative electrode binder is 700,000 to 1,200,000. In an embodiment of this application, the weight-average molecular weight of the negative electrode binder is 800,000 to 1,200,000. Controlled to fall within the above ranges, the weight-average molecular weight of the negative electrode binder improves the kinetic performance of the secondary battery, for example, shortens the charging time, suppresses the lithium plating, and improves the cycle performance.

In an embodiment of this application, a chemical formula of the acrylate ester is CH₂═CH—COO—CₙH₂ₙ₊₁, and n is 3 to 9. In an embodiment of this application, a chemical formula of the acrylate ester is CH₂═CH—COO—CₙH₂ₙ₊₁, and n is 3 to 5. When the above types of acrylate ester are applied to the negative electrode binder, the negative electrode binder possesses a strong bonding force and high kinetic performance, thereby improving the kinetic performance of the secondary battery, for example, shortening the charging time, suppressing the lithium plating, and improving the cycle performance.

In an embodiment of this application, based on a mass of the second active layer, a mass percent of the negative electrode binder in the second active layer is 0.05% to 0.65%; and, based on a mass of the first active layer, a mass percent of the negative electrode binder in the first active layer is 1.3% to 3.0%. The mass percent of the negative electrode binder in the first active layer and the mass percent of the negative electrode binder in the second active layer are controlled to fall within the above ranges, thereby further reducing the content of the binder in the second active layer. In this way, the second active material exposes more active sites, thereby facilitating intercalation and deintercalation of lithium ions. However, when the mass percent of the negative electrode binder in the second active layer is relatively low, for example, is close to 0, a risk of shedding active powder occurs during processing, and the active layer is prone to be debonded during use, thereby impairing the performance of the secondary battery. In addition, when the mass percent of the binder in the first active layer close to the negative current collector side falls within the above range, the bonding force between the first active layer and the negative current collector can be maintained effectively. In this way, the first active layer and the second active layer can be directly applied without using an undercoat during production of the negative electrode plate, thereby improving the kinetic performance of the secondary battery, for example, shortening the charging time, suppressing the lithium plating, improving the cycle performance, and achieving a relatively high energy density of the secondary battery.

In an embodiment of this application, a ratio of a thickness of the first active layer to a thickness of the second active layer is in a range of 1:1 to 4:1, and the thickness of the first active layer is 25 μm to 80 μm. Controlled to fall within the above ranges, the ratio of a thickness of the first active layer to a thickness of the second active layer as well as the thickness of the first active layer improve the kinetic performance of the secondary battery, for example, shorten the charging time, suppress the lithium plating, and improve the cycle performance.

In an embodiment of this application, a sum of the thickness of the first active layer and the thickness of the second active layer is 50 μm to 150 μm. Controlled to fall within the above ranges, the sum of the thickness of the first active layer and the thickness of the second active layer improves the kinetic performance of the secondary battery, for example, shortens the charging time, suppresses the lithium plating, and improves the cycle performance.

In an embodiment of this application, the first active layer further includes a first active material and a first thickener. The second active layer further includes a second active material and a second thickener. The first active material and the second active material each independently include at least one of graphite, hard carbon, soft carbon, silicon, a silicon-carbon compound, or a silicon-oxygen compound. The first thickener and the second thickener each independently include at least one of lithium carboxymethyl cellulose (CMC-Li) or sodium carboxymethyl cellulose (CMC-Na).

A second aspect of this application provides an electronic device. The electronic device includes the secondary battery disclosed in any one of the preceding embodiments. Therefore, the electronic device exhibits superior operating performance.

Some of the beneficial effects of this application are as follows:

This application provides a secondary battery and an electronic device. The secondary battery includes a negative electrode plate. A first active layer and a second active layer doped with a negative electrode binder at different mass percentages are disposed on the negative current collector of the negative electrode plate. Specifically, the mass percent of the negative electrode binder in the first active layer adjacent to the negative current collector is relatively high, and the mass percent of the negative electrode binder in the second active layer is relatively low. In the negative electrode plate of this application, the bonding strength is relatively high between the first active layer and the negative current collector, and the content of the negative electrode binder in the second active layer is relatively low, thereby accelerating migration of lithium ions into the active material particles and into the active material layer. In this way, the probability of lithium ions being richly concentrated on the surface of the negative electrode plate is reduced, and in turn, the kinetic performance of the secondary battery is improved. For example, the charging time is shortened, the lithium plating is suppressed, and the cycle performance is improved. In addition, the relatively high bonding strength between the first active layer and the negative current collector enables the first active layer and the second active layer to be applied directly without using an undercoat during production of the negative electrode plate, thereby reducing the thickness of the negative electrode plate and the volume of the secondary battery, and achieving a relatively high energy density.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is a cross-sectional schematic view of a negative electrode plate sectioned along a thickness direction of the electrode plate according to some embodiments of this application;

FIG. 2 is a cross-sectional schematic view of a negative electrode plate

sectioned along a thickness direction of the electrode plate according to some other embodiments of this application; and

FIG. 3 is a thermogravimetric analysis graph according to Embodiment 1-5 of this application.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person skilled in the art based on this application still fall within the protection scope of this application.

It is hereby noted that in specific embodiments of this application, this application is construed by using a lithium-ion battery as an example of the secondary battery, but the secondary battery of this application is not limited to the lithium-ion battery. Specific technical solutions are as follows:

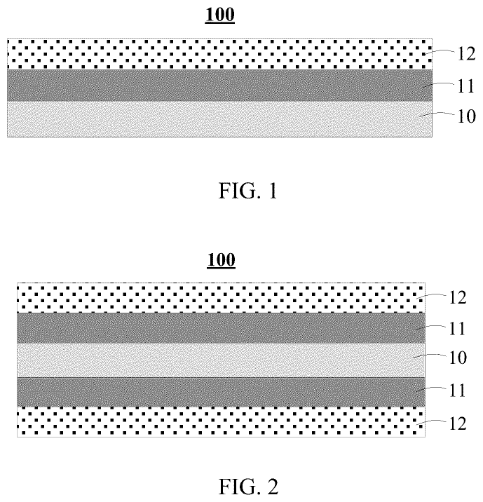

A first aspect of this application provides a secondary battery. The secondary battery includes a negative electrode plate. As shown in FIG. 1 and FIG. 2, the negative electrode plate 100 includes a negative current collector 10, a first active layer 11, and a second active layer 12. The first active layer 11 is disposed between the negative current collector 10 and the second active layer 12. In some embodiments, as shown in FIG. 1, the first active layer 11 and the second active layer 12 are disposed on one surface of the negative current collector 10. In some other embodiments, as shown in FIG. 2, the first active layer 11 and the second active layer 12 are disposed on both surfaces of the negative current collector 10. The “surface” may be a partial or entire surface of the negative current collector. In a thermogravimetric analysis, a weight loss rate T₁ of the first active layer in a temperature range of 350° C. to 500° C. is 1.3% to 3.0%, and a weight loss rate T₂ of the second active layer in a temperature range of 350° C. to 500° C. is 0% to 0.65%. For example, in a thermogravimetric analysis, the weight loss rate of the first active layer in a temperature range of 350° C. to 500° C. is 1.3%, 1.4%, 1.6%, 1.8%, 2.0%, 2.2%, 2.4%, 2.6%, 2.8%, 3.0%, or a value falling within a range formed by any two thereof. For example, in a thermogravimetric analysis, the weight loss rate of the second active layer in a temperature range of 350° C. to 500° C. is 0%, 0.05%, 0.15%, 0.25%, 0.35%, 0.45%, 0.55%, 0.65%, or a value falling within a range formed by any two thereof. Through research, the applicant hereof finds that, when the mass percent of the binder in the active layer adjacent to the negative current collector is relatively high, the transmission of lithium ions is prone to be hindered. When the mass percent of the binder is relatively low, the bonding force between the negative current collector and the active layer is relatively low, and the active layer is prone to be debonded, thereby hindering the use of the secondary battery. In the negative electrode plate of this application, a first active layer and a second active layer doped with a negative electrode binder at different mass percentages are disposed on the negative current collector. Specifically, the mass percent of the negative electrode binder in the first active layer adjacent to the negative current collector is relatively high, and the mass percent of the negative electrode binder in the second active layer is relatively low. In a thermogravimetric analysis, when the weight loss rate T₁ of the first active layer in a temperature range of 350° C. to 500° C. is less than 1.4%, the mass percent of the negative electrode binder in the first active layer is overly low, thereby weakening the bonding strength between the negative current collector and the first active layer, making the first active layer and the second active layer prone to be debonded from the negative current collector, and impairing the operating performance of the secondary battery. In a thermogravimetric analysis, when the weight loss rate T₁ of the first active layer in a temperature range of 350° C. to 500° C. is greater than 3.0%, the mass percent of the negative electrode binder in the first active layer is overly high, thereby impairing the migration speed of lithium ions in the first active layer. In a thermogravimetric analysis, when the weight loss rate T₂ of the second active layer in a temperature range of 350° C. to 500° C. is less than 0.05%, the mass percent of the negative electrode binder in the second active layer is overly low, thereby weakening the bonding strength between the second active layer and the first active layer. In a thermogravimetric analysis, when the weight loss rate T₂ of the second active layer in a temperature range of 350° C. to 500° C. is greater than 0.65%, the mass percent of the negative electrode binder in the second active layer is overly high, thereby slowing down the migration speed of lithium ions in the second active layer and the first active layer, and in turn, impairing the kinetic performance of the secondary battery, for example, increasing the charging time, and aggravating the lithium plating and the cycle performance. In the negative electrode plate of this application, the bonding strength is relatively high between the first active layer and the negative current collector, and the content of the negative electrode binder in the second active layer is relatively low, thereby accelerating migration of lithium ions into the active material particles and into the active material layer. In this way, the probability of lithium ions being richly concentrated on the surface of the negative electrode plate is reduced, and in turn, the kinetic performance of the secondary battery is improved. For example, the charging time is shortened, the lithium plating is suppressed, and the cycle performance is improved. In addition, the relatively high bonding strength between the first active layer and the negative current collector enables the first active layer and the second active layer to be applied directly without using an undercoat during production of the negative electrode plate, thereby reducing the thickness of the negative electrode plate and the volume of the secondary battery, and achieving a relatively high energy density. In this application, the active material layer means a first material layer and a second material layer.

In an embodiment of this application, the first active layer and the second active layer each independently include a negative electrode binder. The negative electrode binder includes a polymer formed by emulsion polymerization of styrene, acrylate ester, and acrylic acid. Based on a mass of the negative electrode binder, a mass percent of the styrene is 5% to 65%, a mass percent of the acrylate ester is 5% to 30%, and a mass percent of the acrylic acid is 5% to 65%. For example, based on the mass of the negative electrode binder, the mass percent of the styrene is 5%, 15%, 25%, 35%, 45%, 55%, 65%, or a value falling within a range formed by any two thereof. For example, based on the mass of the negative electrode binder, the mass percent of the acrylate ester is 5%, 10%, 15%, 20%, 25%, 30%, or a value falling within a range formed by any two thereof. For example, based on the mass of the negative electrode binder, the mass percent of the acrylic acid is 5%, 15%, 25%, 35%, 45%, 55%, 65%, or a value falling within a range formed by any two thereof. In some embodiments, the negative electrode binder in the first active layer is the same as that in the second active layer. In some other embodiments, the negative electrode binder in the first active layer is different from that in the second active layer. When the polymer formed by emulsion polymerization of the styrene, acrylate ester, and acrylic acid added at a mass percent in the above ranges is used as a negative electrode binder, the negative electrode binder exhibits a high bonding force, and can provide relatively high kinetic performance for the secondary battery. In addition, the negative electrode binder applied to the negative electrode plate endows the negative electrode plate with high processability. In this way, the kinetic performance of the secondary battery is improved. For example, the charging time is shortened, and the lithium plating is suppressed, and the cycle performance is improved.

In an embodiment of this application, based on the mass of the negative electrode binder, a sum of the mass percentages of the styrene and the acrylate acid is 70% to 95%, and the mass percent of the acrylate ester is 5% to 30%. For example, based on the mass of the negative electrode binder, the sum of the mass percentages of the styrene and the acrylate acid is 70%, 75%, 80%, 85%, 90%, 95%, or a value falling within a range formed by any two thereof. For example, based on the mass of the negative electrode binder, the mass percent of the acrylate ester is 5%, 10%, 15%, 20%, 25%, 30%, or a value falling within a range formed by any two thereof. Increasing the content of the acrylate ester appropriately can improve the toughness of the binder and ensure smooth processing. In this case, the content of the acrylate ester is relatively low, the degree of swelling of the binder is lowered, and the kinetics are higher. In an embodiment of this application, the sum of the mass percentages of the styrene and the acrylate acid is 70% to 90%, and the mass percent of the acrylate ester is 10% to 30%, thereby further improving the kinetics, and suppressing the lithium plating. When the polymer formed by emulsion polymerization of the styrene, acrylate ester, and acrylic acid added at a mass percent in the above ranges is used as a negative electrode binder, the negative electrode binder exhibits a high bonding force, and can further provide relatively high kinetic performance for the secondary battery. In addition, the negative electrode binder applied to the negative electrode plate further endows the negative electrode plate with high processability. In this way, the kinetic performance of the secondary battery is further improved. For example, the charging time is shortened, and the lithium plating is suppressed, and the cycle performance is improved.

In an embodiment of this application, a weight-average molecular weight of the negative electrode binder is 700,000 to 1,200,000. For example, the weight-average molecular weight of the negative electrode binder is 700,000, 800,000, 900,000, 1,000,000, 1,100,000, 1,200,000, or a value falling within a range formed by any two thereof. The weight-average molecular weight of the negative electrode binder is controlled to fall within the above range, and the negative electrode binder applied to the first active layer and the second active layer can be evenly distributed in the first active layer and the second active layer. In this way, the negative electrode bonding force in the first active layer and the negative electrode bonding force in the second active layer can work to maximum effect. The bonding force between the first active layer and the negative current collector is relatively high, and the second active material in the second active layer exposes more active sites to facilitate intercalation and deintercalation of lithium ions. In an embodiment of this application, the weight-average molecular weight of the negative electrode binder is 800,000 to 1,200,000, thereby further improving the kinetic performance, and suppressing the lithium plating. In this way, the first active layer and the second active layer can be applied directly without using an undercoat during production of the negative electrode plate, thereby improving the kinetic performance of the secondary battery, for example, shortening the charging time, suppressing the lithium plating, and improving the cycle performance.

The method for adjusting and controlling the weight-average molecular weight of the negative electrode binder is not particularly limited herein, as long as the objectives of this application can be achieved. For example, the weight-average molecular weight may be controlled by adjusting the amount of an initiator and an emulsifier added during preparation of the negative electrode binder, or by purchasing an appropriate product from manufacturers. The higher the content of the initiator and emulsifier, the smaller the weight-average molecular weight of the negative electrode binder.

In an embodiment of this application, a chemical formula of the acrylate ester is CH₂═CH—COO-CₙH₂ₙ₊₁, and n is 3 to 9. For example, n is 3, 4, 5, 6, 7, 8, or 9. In some embodiments, the acrylate ester includes at least one of CH₂═CH—COO—C₃H₇, CH₂═CH—COO—C₄H₉, CH₂═CH—COO—C₅H₁₁, CH₂═CH—COO—C₆H₁₃, CH₂═CH—COO—C₇H₁₅, CH₂═CH—COO—C₈H₁₇, or CH₂═CH—COO—C₉H₁₉. In some other embodiments, the acrylate ester includes any one of CH₂═CH—COO—C₃H₇, CH₂═CH—COO—C₄H₉, CH₂═CH—COO—C₅H₁₁, CH₂═CH—COO—C₆H₁₃, CH₂═CH—COO—C₇H₁₅, CH₂═CH—COO—C₈H₁₇, or CH₂═CH—COO—C₉H₁₉. The content of the ester group in the acrylate ester affects the polymerization reactions between the acrylate ester and the styrene, and between the acrylate ester and the acrylic acid, and affects the degree of swelling of a polymer in an electrolyte solution, where the polymer is formed by polymerizing the acrylate ester, styrene, and acrylic acid. When n is controlled to fall within the above range, the content of the ester group in the acrylate ester falls within an appropriate range, and the acrylate ester exhibits superior polymerization properties. When the above types of acrylate ester are applied to the negative electrode binder, the negative electrode binder possesses a strong bonding force and high kinetic performance, thereby improving the kinetic performance of the secondary battery, for example, shortening the charging time, suppressing the lithium plating, and improving the cycle performance. In an embodiment of this application, a chemical formula of the acrylate ester is CH₂═CH—COO—CₙH₂ₙ₊₁, and n is 3 to 5, thereby further suppressing the lithium plating.

In an embodiment of this application, based on a mass of the second active layer, a mass percent W_{f2} of the negative electrode binder is 0.05% to 0.65%, and further, the mass percent W_{f2} of the negative electrode binder is 0.05% to 0.4%. Based on a mass of the first active layer, a mass percent W_{f1} of the negative electrode binder is 1.3% to 3.0%. For example, based on the mass of the second active layer, the mass percent of the negative electrode binder is 0.05%, 0.15%, 0.25%, 0.35%, 0.45%, 0.55%, 0.65%, or a value falling within a range formed by any two thereof. For example, based on the mass of the first active layer, the mass percent of the negative electrode binder is 1.3%, 1.4%, 1.6%, 1.8%, 2.0%, 2.2%, 2.4%, 2.6%, 2.8%, 3.0%, or a value falling within a range formed by any two thereof. When the mass percent of the negative electrode binder in the first active layer and the mass percent of the negative electrode binder in the second active layer are controlled to fall within the above ranges, the bonding strength between the first active layer and the negative current collector is relatively high, and the content of the binder in the second active layer is further reduced, so that the negative active material exposes more active sites to accelerate the migration of lithium ions into the active material particles and the active material layer. In this way, the probability of lithium ions being richly concentrated on the surface of the negative electrode plate is reduced, and in turn, the kinetic performance of the secondary battery is improved. For example, the charging time is shortened, the lithium plating is suppressed, and the cycle performance is improved. In addition, the relatively high bonding strength between the first active layer and the negative current collector enables the first active layer and the second active layer to be applied directly without using an undercoat during production of the negative electrode plate, thereby reducing the thickness of the negative electrode plate and the volume of the secondary battery, and achieving a relatively high energy density.

In an embodiment of this application, a thickness ratio between of a thickness of the first active layer and to a thickness of the second active layer is in a range of 1:1 to 4:1, and the thickness of the first active layer is 25 μm to 80 μm. For example, a ratio of a thickness of the first active layer to a thickness of the second active layer is 1:1, 2:1, 3:1, 4:1, or a ratio value falling within a range formed by any two thereof. For example, the thickness of the first active layer is 25 μm, 35 μm, 45 μm, 55 μm, 65 μm, 75 μm, 80 μm, or a value falling within a range formed by any two thereof. When the ratio of a thickness of the first active layer to a thickness of the second active layer as well as the thickness of the first active layer are controlled to fall within the above ranges, the thickness of the first active layer containing a relatively high content of the negative electrode binder is relatively small. In this way, on the premise that high bonding strength exists between the negative current collector and the first active layer, the kinetic performance of the first active layer and the second active layer is superior. The lithium ions in the first active layer and the second active layer can be migrated at a relatively high speed, and can be quickly migrated into the active material particles and into the active material layer, thereby improving the kinetic performance of the secondary battery, for example, shortening the charging time, suppressing the lithium plating, and improving the cycle performance. In addition, the thickness of the first active layer and the thickness of the second active material are relatively small, thereby reducing the thickness of the negative electrode plate, reducing the volume of the secondary battery, and in turn, endowing the secondary battery with a relatively high energy density.

In an embodiment of this application, a sum of the thickness of the first active layer and the thickness of the second active layer is 50 μm to 150 μm. For example, the sum of the thickness of the first active layer and the thickness of the second active layer is 50 μm, 60 μm, 70 μm, 80 μm, 90 μm, 100 μm, 110 μm, 120 μm, 130 μm, 140 μm, 150 μm, or a value falling within a range formed by any two thereof. The sum of the thickness of the first active layer and the thickness of the second active layer is controlled to fall within the above range, the first active layer and the second active layer are relatively thin on the premise of achieving superior kinetic performance. In this way, the kinetic performance of the secondary battery is improved. For example, the charging time is shortened, the lithium plating is suppressed, and the cycle performance is improved. In addition, the secondary battery is endowed with a relatively high energy density.

The thickness of the second active layer is not particularly limited herein, as long as the objectives of this application can be achieved. For example, the thickness of the second active layer is 10 μm to 75 μm.

It is hereby noted that, in this application, the thickness of the first active layer and the thickness of the second active layer mean the thickness of the first active layer and the thickness of the second active layer that have been cold-pressed.

In an embodiment of this application, the first active layer further includes a first active material and a first thickener. The second active layer further includes a second active material and a second thickener. The first active material and the second active material each independently include at least one of graphite, hard carbon, soft carbon, silicon, a silicon-carbon compound, or a silicon-oxygen compound. The first thickener and the second thickener each independently include at least one of lithium carboxymethyl cellulose or sodium carboxymethyl cellulose. The above types of first active material, first thickener, second active material, and second thickener are conducive to improving the kinetic performance of the secondary battery, for example, shortening the charging time, suppressing the lithium plating, and improving the cycle performance.

In an embodiment of this application, based on the mass of the first active layer, the mass percent of the first active material is 96% to 97.5%, and the mass percent of the first thickener is 1.0% to 1.5%.

In an embodiment of this application, based on the mass of the second active layer, the mass percent of the second active material is 97.4% to 98.7%, and the mass percent of the second thickener is 1.0% to 2.0%.

The negative current collector is not particularly limited herein, as long as the objectives of this application can be achieved. For example, the negative current collector may include a copper foil, copper alloy foil, nickel foil, stainless steel foil, titanium foil, foamed nickel, foamed copper, or the like. The thickness of the negative current collector is not particularly limited herein, as long as the objectives of this application can be achieved. For example, the thickness of the negative current collector is 4 μm to 10 μm.

The method for preparing the negative electrode plate is not particularly limited herein, as long as the objectives of this application can be achieved. For example, a method for preparing a negative electrode plate includes but is not limited to the following steps: (1) dissolving the first active material, the first thickener, and the negative electrode binder at a mass ratio of (96 to 97.5): (1.0 to 1.5): (1.3 to 3.0) in a solvent, and stirring well to obtain a first active slurry in which the solid content is 40 wt % to 50 wt %; (2) dissolving the second active material, the second thickener, and the negative electrode binder at a mass ratio of (97.4 to 98.7): (1.0 to 2.0): (0.05 to 0.65) in a solvent, and stirring well to obtain a second active slurry in which the solid content is 40 wt % to 50 wt %; and (3) applying the above-prepared first active slurry and second active slurry onto one surface of the negative current collector simultaneously by using a coating machine with a double-layer coating die, so that the first active slurry contacts the negative current collector to form a first active layer, and the second active slurry contacts the first active slurry to form a second active layer; and drying the slurries at 60° C. to 110° C. to obtain a negative electrode plate coated with the first active layer and the second active layer on a single side. To prepare a negative electrode plate coated with the first active layer and the second active layer on both sides, step (3) is repeated on the other surface of the negative current collector. The speed of the coating machine in step (3) is not particularly limited herein, as long as the objectives of this application can be achieved. The areal densities of the first active layer and the second active layer are not particularly limited herein, as long as the thickness of the first active layer and the thickness of the second active layer are made to fall within the ranges specified herein.

The method for preparing the negative electrode binder in step (1) and step (2) above is not particularly limited herein, as long as the objectives of this application can be achieved. For example, the negative electrode binder may be prepared by the following method: (i) adding water, emulsifier, and lithium carbonate into a three-neck flask, where the mass ratio between the water, emulsifier, and lithium carbonate is 1: (0.2 to 0.4): 0.3, the volume of water is 200 mL to 300 mL, and the types of the emulsifier include but are not limited to sodium dodecyl sulfate; (ii) mixing, in a beaker, the required monomers (acrylic acid, styrene, and acrylate ester) with water at a mass ratio of 1: (0.5 to 0.6) to form a mixed solution, adding the mixed solution at a mass percent of 35% to 45% into the three-neck flask, stirring at a speed of 245 rpm to 255 rpm, and heating the mixture until 75° C. to 85° C.; (iii) mixing an initiator with water in the beaker to obtain a 0.2% initiator solution (that is, the mass percent of the initiator is 0.2%), where the mass of the initiator is 0.4 g to 0.6 g, and the types of the initiator include but are not limited to ammonium persulfate; and (iv) adding the initiator solution at a mass percent of 35% to 45% into the three-neck flask to start reaction; dripping, after reacting for 0.5 h to 1.5 h, the remaining mixed solution (mass percent: 55% to 65%) and the remaining initiator solution (mass percent: 55% to 65%) into the three-neck flask through a peristaltic pump, and reacting for 5.5 h to 6.5 h to obtain the desired negative electrode binder. It is hereby noted that the preparation method of the negative electrode binder includes, but is not limited to, the above method.

In an embodiment of this application, the secondary battery further includes a positive electrode plate. In this application, the positive electrode plate is not particularly limited, as long as the objectives of this application can be achieved. For example, the positive electrode plate includes a positive current collector and a positive active material layer disposed on at least one surface of the positive current collector.

The type of the positive current collector is not particularly limited herein, as long as the objectives of this application can be achieved. For example, the positive current collector may include aluminum foil, aluminum alloy foil, or the like. The positive active material layer of this application includes a positive active material. The type of the positive active material is not particularly limited herein, as long as the positive active material contains the transition metal element specified herein and can achieve the objectives of this application. For example, the positive active material may include at least one of lithium nickel cobalt manganese oxide, lithium nickel cobalt aluminum oxide, lithium iron phosphate, a lithium-rich manganese-based material, lithium cobalt oxide, lithium manganese oxide, lithium manganese iron phosphate, lithium titanium oxide, or the like. In this application, the positive active material may further include a non-metallic element. For example, the non-metallic elements include at least one of fluorine, phosphorus, boron, chlorine, silicon, or sulfur. Such elements can further improve the stability of the positive active material. In this application, the thickness of the positive current collector and the thickness of the positive active material layer are not particularly limited, as long as the objectives of this application can be achieved. For example, the thickness of the positive current collector is 5 μm to 20 μm. The thickness of the positive active material layer is 30 μm to 120 μm. Optionally, the positive active material layer may further include a positive conductive agent and a positive binder. The types of the positive conductive agent and the positive binder in the positive active material layer are not particularly limited herein, as long as the objectives of this application can be achieved. The mass ratio between the positive active material, the positive conductive agent, and the positive binder in the positive active material layer is not particularly limited herein, and may be selected by a person skilled in the art as actually required, as long as the objectives of this application can be achieved. For example, the mass ratio between the positive active material, the positive conductive agent, and the positive binder in the positive active material layer is (97 to 98): (0.5 to 1.5): (1.5 to 3.4).

In an embodiment of this application, the secondary battery further includes a separator. The separator is disposed between the positive electrode plate and the negative electrode plate to separate the positive electrode plate from the negative electrode plate, prevent an internal short circuit of the electrochemical device, and allow electrolyte ions to pass freely without affecting the electrochemical charging and discharging processes. The separator is not particularly limited herein, as long as the objectives of this application can be achieved. For example, the separator may be made of a material including but not limited to at least one of: a polyethylene (PE)- or polypropylene (PP)-based polyolefin (PO), a polyester (such as polyethylene terephthalate (PET) film), cellulose, polyimide (PI), polyamide (PA), spandex, or aramid. The type of the separator may include a woven film, a non-woven film, a microporous film, a composite film, a calendered film, or a spinning film.

In an embodiment of this application, the secondary battery further includes a packaging bag and an electrolyte solution. The electrolyte solution, positive electrode plate, separator, and negative electrode plate are accommodated in the packaging bag. The packaging bag and the electrolyte solution are not particularly limited herein, and may be a packaging bag and electrolyte solution well-known in the art, as long as the objectives of this application can be achieved.

The type of the secondary battery is not particularly limited herein, and may be any device in which an electrochemical reaction occurs. For example, the secondary battery may be, but is not limited to, a lithium metal secondary battery, a lithium-ion secondary battery (lithium-ion battery), a sodium-ion secondary battery (sodium-ion battery), a lithium polymer secondary battery, or a lithium-ion polymer secondary battery (lithium-ion polymer battery).

The process of preparing the secondary battery in this application is well known to a person skilled in the art, and is not particularly limited herein. For example, the preparation process may include, but is not limited to, the following steps: stacking the positive electrode plate, the separator, and the negative electrode plate in sequence, and performing operations such as winding as required to obtain a jelly-roll electrode assembly; putting the electrode assembly into a package, injecting the electrolyte solution into the package, and sealing the package to obtain a secondary battery; or, stacking the positive electrode plate, the separator, and the negative electrode plate in sequence, and then fixing the four corners of the entire stacked structure by use of adhesive tape to obtain a stacked-type electrode assembly, putting the electrode assembly into a package, injecting the electrolyte solution into the package, and sealing the package to obtain a secondary battery. In addition, an overcurrent prevention element, a guide plate, and the like may be placed into a pocket as required, so as to prevent the rise of internal pressure, overcharge, and overdischarge of the secondary battery.

A second aspect of this application provides an electronic device. The electronic device includes the secondary battery disclosed in any one of the preceding embodiments. Therefore, the electronic device exhibits superior operating performance.

The electronic device is not particularly limited herein, and may be any electronic device known in the prior art. For example, the electronic device may include, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### Embodiments

The implementations of this application are described below in more detail with reference to embodiments and comparative embodiments. Various tests and evaluations are performed by the following methods.

### Test Methods and Devices

### Thermogravimetric Analysis (TG) Test:

Fully discharging a lithium-ion battery, disassembling the battery to obtain a negative electrode plate, and soaking the negative electrode plate in dimethyl carbonate (DMC) for 2 hours, and then taking out and drying the negative electrode plate.

For the TG test on the second active layer, scraping off powder of the negative electrode plate from a depth of 10 μm or less near the superficial layer of the negative electrode plate by using a scraper, using 3 mg of the powder as a specimen for the TG test, and setting the test temperature to a range of 350° C. to 500° C.

For the TG test on the first active layer, scraping off powder of the negative electrode plate from a depth of 10 μm or less near the surface of the negative current collector by using a scraper, using 3 mg of the powder as a specimen for the TG test, and setting the test temperature to a range of 350° C. to 500° C.

### Testing the Type and Mass Percent of Monomer Constituents in the Negative Electrode Binder:

The type and mass percent of monomer constituents in the negative electrode binder may be quantitatively analyzed by pyrolysis-gas chromatography-mass spectrometry (py-GCMS).

The test instrument is a gas chromatography mass spectrometry instrument. An exemplary test method is: Fully discharging a lithium-ion battery, disassembling the battery to take out a negative electrode plate, soaking the negative electrode plate in DMC for 10 hours, and then replacing the DMC solution and soaking the negative electrode plate for another 14 hours; taking out the soaked negative electrode plate, placing the electrode plate in a vacuum oven to bake the electrode plate at 85° C. for 15 hours; scraping off the second active layer and the first active layer separately with a scraper after the negative electrode plate is dried thoroughly; taking 1.0 g of the second active layer powder and 1.0 g of the first active layer powder as specimens separately, and placing the specimens into a specimen crucible to undergo a py-GCMS test, so as to obtain the type and mass percent of each monomer constituent in the negative electrode binder in the second active layer as well as the type and mass percent of each monomer constituent in the negative electrode binder in the first active layer.

In the Py-GCMS test, the pyrolysis temperature range is 40° C. to 1000° C., the atmosphere is helium, and the polymer (negative electrode binder) is pyrolyzed into small molecular fragments at high temperature. When the small molecules pass through a chromatographic column, due to difference in polarity and difference in the adsorption force of the chromatographic column, the time taken for the small molecular fragments to flow out of the chromatographic column varies, thereby obtaining different chromatogram elution curves; and comparing the standard spectra of different small molecules with the elution volumes of the corresponding small molecules to obtain the type and mass percent of each monomer constituent in the negative electrode binder.

### Testing the Bonding Force:

(1) Cutting a dried negative electrode plate into specimens by using a cutter, each specimen being 30 mm wide and 130 mm long.

(2) Sticking a special-purpose double-sided tape (manufacturer: NITTO, model: 5000NS) onto a steel sheet, where the double-sided tape is 20 mm wide and 60 mm long.

(3) Sticking the specimen onto the double-sided tape.

(4) Turning on a SUNS tensile tester so that the indicator is on, clamping one end of the specimen between two constraining blocks of a jig of the tensile tester, adjusting the constraining blocks to initial positions, and starting to test the tensile force and obtaining a displacement-tension curve, and defining an average of the measured tensile force values as the bonding force. Understandably, the bonding force is a bonding force between the first active layer and the negative current collector.

### Testing the 3.5 C Charging Time:

(1) Mounting a lithium-ion battery specimen onto an electrochemical workstation, and setting the test temperature to 25° C.

(2) Discharging the lithium-ion battery at a current of 0.5 C until the voltage reaches 3.0 V.

(3) Charging the battery at a constant current of 3.5 C until the voltage reaches 4.5 V, and then charging the battery at a constant voltage until the current drops to 0.02 C.

(4) Leaving the battery to stand for 5 min.

(5) Recording the time taken in step (3) above as a 3.5 C charging time.

### Testing the Capacity Retention Rate of the Battery Cycled at 45° C. and 3 C for 600 Cycles:

(1) Mounting a lithium-ion battery specimen onto an electrochemical workstation, setting the test temperature to 45° C., and leaving the battery to stand for 30 min.

(2) Charging the battery at a constant current of 3.0 C until the voltage reaches 4.5 V, and then charging the battery at a constant voltage until the current drops to 0.02 C.

(3) Leaving the battery to stand for 5 min.

(4) Discharging the battery at a current of 0.5 C until the voltage drops to 3.0 V.

(5) Leave the battery to stand for 5 min, and then recording the capacity of the lithium-ion battery as C₀.

(6) Repeating the above steps (2) to (5) for 600 cycles, and recording the capacity at the end of the 600^{th} cycle as C₁.

(7) Capacity retention rate of the battery cycled at 45° C. and 3 C for 600 cycles=C₁/C₀×100%.

### Testing 25° C. Persistent-Charging Lithium Plating (Maximum C-Rate Free From Lithium-Plating):

(1) Mounting 11 lithium-ion battery specimens onto an electrochemical workstation, setting the test temperature to 25° C., and leaving the batteries to stand for 60 min.

(2) Discharging the battery at a current of 0.5 C until the voltage drops to 3.0 V, and leaving the battery to stand for 5 min.

(3) Charging lithium-ion batteries at a constant current of XC until the voltage reaches 4.5 V, and then charging the batteries at a constant voltage until the current drops to 0.05 C, and leaving the batteries to stand for 5 min, where X is 3.5 to 4.5, X starts at 3.5 and increases by steps of 0.1, and each lithium-ion battery is charged at a C-rate equal to C multiplied by a different X value. For example, the first X value is 3.5, the second X value is 3.6, . . . , and the 11^{th} X value is 4.5, ensuring that at least one lithium-ion battery is tested for each X value.

(4) Repeating the above steps (2) to (3) for 10 cycles.

(5) Fully charging and then disassembling each lithium-ion battery to check whether lithium plating occurs on the surface of the negative electrode plate, and determining that the maximum X value causing no lithium plating is the maximum C-rate free from lithium-plating.

### Embodiment 1-1

### <Preparing a Negative Electrode Plate>

Dissolving graphite as a first active material, lithium carboxymethyl cellulose as a first thickener, and a negative electrode binder at a mass ratio of 95.7:1.3:3 in deionized water, and stirring well to obtain a first active slurry in which the solid content is 47 wt %.

Dissolving graphite as a second active material, lithium carboxymethyl cellulose as a second thickener, and a negative electrode binder at a mass ratio of 98.2:1.3:0.5 in deionized water, and stirring well to obtain a second active slurry in which the solid content is 47 wt %.

Applying the above-prepared first active slurry and second active slurry onto one surface of a 6 μm-thick negative current collector copper foil simultaneously at a speed of 15 m/min by using a coating machine with a double-layer coating die, so that the first active slurry contacts the copper foil to form a first active layer, and the second active slurry contacts the first active slurry to form a second active layer, where the areal densities of both the first active layer and the second active layer are 3.76 mg/cm²; and drying the slurries at 80° C. to obtain a negative electrode plate coated with the first active layer and the second active layer on a single side. Subsequently, repeating the foregoing steps on the other surface of the copper foil to obtain a negative electrode plate coated with the first active layer and the second active layer on both sides. Performing cold-pressing, cutting, and tab welding to obtain a negative electrode plate of 76 mm × 867 mm in size for further use. The compaction density of the cold-pressed negative electrode plate is 1.75 g/cm³.

The negative electrode binder is a polymer formed by emulsion polymerization of styrene, acrylate ester CH₂═CH—COO—C₅H₁₁, and acrylic acid. Based on the mass of the negative electrode binder, the mass percent of the styrene is W₁=60%, the mass percent of the acrylate ester is W₂=20%, and the mass percent of the acrylate acid is W₃=20%. The weight-average molecular weight of the negative electrode binder is 800,000.

The thickness of the first active layer is 25 μm, and the thickness of the second active layer is 25 μm. The ratio of the thickness of the first active layer to the thickness of the second active layer is 1:1. The sum of the thickness of the first active layer and the thickness of the second active layer is 50 μm.

### <Preparing a Positive Electrode Plate>

Mixing lithium cobalt oxide as a positive active material, polyvinylidene difluoride (PVDF) as a positive electrode binder, carbon nanotubes as a positive conductive agent at a mass ratio of 98:1:1, adding N-methyl-pyrrolidone (NMP) as a solvent, and stirring the mixture with a vacuum mixer until the system is homogeneous, so as to obtain a positive electrode slurry in which the solid content is 75 wt %. Applying the positive electrode slurry evenly onto one surface of a 6 μm-thick positive current collector aluminum foil until the wet film thickness satisfies a concentration of 250 g/m². Drying the slurry at 120° C. to obtain a positive electrode plate coated with a positive active material layer on a single side. Subsequently, repeating the foregoing steps on the other surface of the aluminum foil to obtain a positive electrode plate coated with the positive active material layer on both sides. Performing cold-pressing, cutting, and tab welding to obtain a positive electrode plate of 74 mm×851 mm in size for further use. The compaction density of the cold-pressed positive electrode plate is 4.2 g/cm³.

### <Preparing a Separator>

Using a 14 μm-thick polyethylene porous polymer film as a separator.

### <Preparing an Electrolyte Solution>

Mixing, in an environment with a water content of less than 10 ppm, lithium hexafluorophosphate (as a lithium salt) with a nonaqueous organic solvent to form an electrolyte solution in which a lithium salt concentration is 1.15 mol/L, where the nonaqueous organic solvent contains ethylene carbonate (EC), propylene carbonate (PC), propyl propionate (PP), and diethyl carbonate (DEC) mixed at a mass ratio of 1:1:1:1.

### <Preparing a Lithium-Ion Battery>

Stacking the positive electrode plate, separator, and negative electrode plate sequentially in such a way that the separator is located between the positive electrode plate and the negative electrode plate to serve a function of separation, and winding the stacked structure to obtain an electrode assembly. Putting the electrode assembly in an aluminum laminated film that serves as a packaging bag, dehydrating the electrode assembly at 80° C., injecting the electrolyte solution, and sealing the package; and performing steps such as chemical formation, capacity grading, degassing, and shaping to obtain a lithium-ion battery.

### Embodiments 1-2 to 1-7

Identical to Embodiment 1-1 except that the relevant preparation parameters are adjusted according to Table 1.

In the first active layer, when the mass percent W_{f1} of the negative electrode binder changes, the mass percent of the first active material changes accordingly, the mass percent of the first thickener remains unchanged, and the sum of the mass percentages of the negative electrode binder, the first active material, and the first thickener is 100%. In the second active layer, when the mass percent Wiz of the negative electrode binder changes, the mass percent of the second active material changes accordingly, the mass percent of the second thickener remains unchanged, and the sum of the mass percentages of the negative electrode binder, the second active material, and the second thickener is 100%.

### Embodiments 2-1 to 2-9

Identical to Embodiment 1-5 except that the relevant preparation parameters are adjusted according to Table 2.

### Embodiments 3-1 to 3-8

Identical to Embodiment 1-3 except that the relevant preparation parameters are adjusted according to Table 3.

### Embodiments 4-1 to 4-3

Identical to Embodiment 1-2 except that the relevant preparation parameters are adjusted according to Table 4.

### Comparative Embodiments 1 to 4

Identical to Embodiment 1-1 except that the relevant preparation parameters are adjusted according to Table 1.

In the first active layer, when the mass percent W_{f1} of the negative electrode binder changes, the mass percent of the first active material changes accordingly, the mass percent of the first thickener remains unchanged, and the sum of the mass percentages of the negative electrode binder, the first active material, and the first thickener is 100%. In the second active layer, when the mass percent W_{f2} of the negative electrode binder changes, the mass percent of the second active material changes accordingly, the mass percent of the second thickener remains unchanged, and the sum of the mass percentages of the negative electrode binder, the second active material, and the second thickener is 100%.

The preparation parameters and performance parameters of each embodiment and each comparative embodiment are shown in Table 1 to Table 4.

TABLE 1

| | | | | | | | | Maximum |
|---|---|---|---|---|---|---|---|---|
| | | | | | | | | C-rate |
| | | | | | Bonding | 3.5 C | Capacity | free from |
| | W_{f1} | T₁ | W_{f2} | T₂ | force | charging | retention | lithium- |
| | (%) | (%) | (%) | (%) | (N/m) | time (min) | rate (%) | plating |
| Embodiment 1-1 | 3 | 2.98 | 0.5 | 0.53 | 16 | 47 | 86.3 | 4.2 C |
| Embodiment 1-2 | 2.6 | 2.59 | 0.05 | 0.06 | 15.3 | 44.1 | 88.1 | 4.5 C |
| Embodiment 1-3 | 2.2 | 2.18 | 0.2 | 0.23 | 14 | 46.0 | 87.1 | 4.3 C |
| Embodiment 1-4 | 2 | 1.97 | 0.4 | 0.42 | 13.6 | 46.0 | 86.8 | 4.3 C |
| Embodiment 1-5 | 1.9 | 1.9 | 0.6 | 0.62 | 13.1 | 47.3 | 85.0 | 4.1 C |
| Embodiment 1-6 | 1.5 | 1.47 | 0.65 | 0.65 | 12 | 46.7 | 86.3 | 4.2 C |
| Embodiment 1-7 | 1.3 | 1.3 | 0.6 | 0.61 | 10.4 | 46.7 | 85.7 | 4.2 C |
| Comparative | 3.2 | 3.18 | 0.2 | 0.2 | 16 | 49.6 | 84.0 | 4.0 C |
| Embodiment 1 | | | | | | | | |
| Comparative | 1.9 | 1.9 | 0.8 | 0.82 | 12.9 | 49 | 84.5 | 3.8 C |
| Embodiment 2 | | | | | | | | |
| Comparative | 1.3 | 1.3 | 1.3 | 1.28 | 10.5 | 50 | 82.6 | 3.5 C |
| Embodiment 3 | | | | | | | | |
| Comparative | 1.2 | 1.2 | 0.7 | 0.71 | 10 | 49 | 83.3 | 3.8 C |
| Embodiment 4 | | | | | | | | |

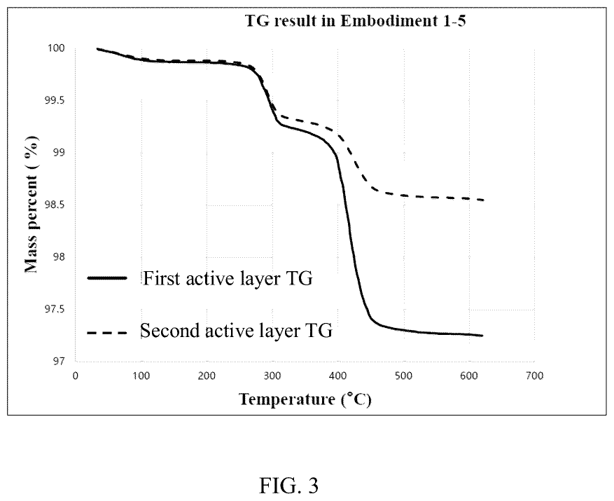

As can be seen from Embodiments 1-1 to 1-7 and Comparative Embodiments 1 to 4, in the negative electrode plate of the secondary battery disclosed in an embodiment of this application, a first active layer and a second active layer that contain the negative electrode binder added at different mass percentages are disposed on the negative current collector. In a thermogravimetric analysis of the negative electrode plate, the weight loss rate T₁ of the first active layer in a temperature range of 350° C. to 500° C. and the weight loss rate T₂ of the second active layer in a temperature range of 350° C. to 500° C. are controlled to fall within the ranges specified herein. In this way, the negative electrode plate is endowed with a relatively high bonding force, the charging time of the secondary battery charged at a charge rate of 3.5 C is shorter, the capacity retention rate of the secondary battery charged and discharged for 600 cycles at a temperature of 45° C. and a C-rate of 3 C is higher, and the maximum C-rate free from lithium plating during persistent charging at 25° C. is higher, indicating that the kinetic performance of the secondary battery in an embodiment of this application is superior, for example, the charging time is relatively short, the cycle performance is superior, and the lithium plating is alleviated. Therefore, the kinetic performance of the secondary battery disclosed in an embodiment of this application is improved. FIG. 3 shows a TG test according to Embodiment 1-5. As can be seen from FIG. 3, the weight loss rate T₁ of the first active layer in a temperature range of 350° C. to 500° C. is 1.9%, and a weight loss rate T₂ of the second active layer in a temperature range of 350° C. to 500° C. is 0.62%. By contrast, in the negative electrode plate of the secondary battery in the comparative embodiment, the first active layer and the second active layer contain the negative electrode binder added at the same mass percent; or, at least one of the weight loss rate T₁ of the first active layer in a temperature range of 350° C. to 500° C. or the weight loss rate T₂ of the second active layer in a temperature range of 350° C. to 500° C. falls outside the ranges specified herein. In this way, the charging time of the secondary battery in the comparative embodiment charged at a charge rate of 3.5 C is longer, the capacity retention rate of the secondary battery charged and discharged for 600 cycles at a temperature of 45° C. and a C-rate of 3 C is lower, and the maximum C-rate free from lithium plating during persistent charging at 25° C. is lower, indicating that the kinetic performance of the secondary battery in the comparative embodiment is inferior. It is hereby noted that, in different embodiments of this application, the mass percent W_{f1} of the binder in the first active layer is the same, but the weight loss rate T₁ of the first active layer in the temperature range of 350° C. to 500° C. is different, and the mass percent W_{f2} of the binder in the second active layer is the same, but the weight loss rate T₂ of the second active layer in the temperature range of 350° C. to 500° C. is different. All these discrepancies are due to test tolerances. Approximate values falling within an acceptable range of process errors are considered roughly equal.

TABLE 2

| | | | | | Weight-average |
|---|---|---|---|---|---|
| | | | | | molecular weight |
| | W₁ | W₂ | W₃ | W₁ + W₃ | of negative |
| | (%) | (%) | (%) | (%) | electrode binder |
| Embodiment 1-5 | 60 | 20 | 20 | 80 | 800,000 |
| Embodiment 2-1 | 40 | 30 | 30 | 70 | 800,000 |
| Embodiment 2-2 | 50 | 20 | 30 | 80 | 800,000 |
| Embodiment 2-3 | 40 | 10 | 50 | 90 | 800,000 |
| Embodiment 2-4 | 40 | 20 | 40 | 80 | 800,000 |
| Embodiment 2-5 | 30 | 10 | 60 | 90 | 800,000 |
| Embodiment 2-6 | 5 | 30 | 65 | 70 | 800,000 |
| Embodiment 2-7 | 90 | 5 | 5 | 95 | 800,000 |
| Embodiment 2-8 | 48 | 2 | 50 | 98 | 800,000 |
| Embodiment 2-9 | 30 | 35 | 35 | 65 | 800,000 |

| | | | | | | Maximum |
|---|---|---|---|---|---|---|
| | | | | | | C-rate |
| | | | Bonding | 3.5 C | Capacity | free from |
| | T₁ | T₂ | force | charging | retention | lithium- |
| | (%) | (%) | (N/m) | time (min) | rate (%) | plating |
| Embodiment 1-5 | 1.9 | 0.62 | 13.1 | 47.3 | 85.0 | 4.1 C |
| Embodiment 2-1 | 1.92 | 0.6 | 13 | 47 | 85.3 | 4.1 C |
| Embodiment 2-2 | 1.9 | 0.62 | 12.5 | 47.3 | 85.5 | 4.2 C |
| Embodiment 2-3 | 1.88 | 0.63 | 12.7 | 47.0 | 85.1 | 4.1 C |
| Embodiment 2-4 | 1.89 | 0.62 | 13 | 47.5 | 85.3 | 4.1 C |
| Embodiment 2-5 | 1.88 | 0.6 | 13.2 | 47.1 | 85.2 | 4.0 C |
| Embodiment 2-6 | 1.90 | 0.61 | 13.2 | 47.4 | 84.9 | 4.0 C |
| Embodiment 2-7 | 1.91 | 0.61 | 13.0 | 48.5 | 85.1 | 4.0 C |
| Embodiment 2-8 | 1.91 | 0.61 | 13.4 | 48 | 85 | 4.0 C |
| Embodiment 2-9 | 1.91 | 0.61 | 13.3 | 48.7 | 84.7 | 3.9 C |

The mass percentages of the styrene, polyacrylate ester, and acrylic acid in the negative electrode binder usually also affect the kinetic performance of the secondary battery. As can be seen from Embodiment 1-5 and Embodiments 2-1 to 2-9, the mass percentages of the styrene, polyacrylate ester, and acrylic acid in the negative electrode binder in the secondary battery fall within the ranges specified herein. Therefore, the charging time of the secondary battery charged at a charge rate of 3.5 C is relatively short, the capacity retention rate of the secondary battery charged and discharged for 600 cycles at a temperature of 45° C. and a C-rate of 3 C is relatively high, and the maximum C-rate free from lithium plating during persistent charging at 25° C. is relatively high, indicating that the kinetic performance of the secondary battery is superior, for example, the charging time is relatively short, the cycle performance is superior, and the lithium plating is alleviated.

TABLE 3

| | | | Weight-average molecular |
|---|---|---|---|
| | | | weight of negative |
| | Acrylate | Scientific name | electrode binder |
| Embodiment 1-3 | CH₂═CH—COO—C₅H₁₁ | n-pentyl acrylate | 800,000 |
| Embodiment 3-1 | CH₂═CH—COO—C₃H₇ | n-propyl acrylate | 900,000 |
| Embodiment 3-2 | CH₂═CH—COO—C₅H₁₁ | n-pentyl acrylate | 900,000 |
| Embodiment 3-3 | CH₂═CH—COO—C₉H₁₉ | 3,5,5-trimethylhexyl | 900,000 |
| | | acrylate | |
| Embodiment 3-4 | CH₂═CH—COO—C₂H₅ | Ethyl acrylate | 900,000 |
| Embodiment 3-5 | CH₂═CH—COO—C₁₀H₂₁ | n-decyl acrylate | 900,000 |
| Embodiment 3-6 | CH₂═CH—COO—C₅H₁₁ | n-pentyl acrylate | 1,200,000 |
| Embodiment 3-7 | CH₂═CH—COO—C₅H₁₁ | n-pentyl acrylate | 600,000 |
| Embodiment 3-8 | CH₂═CH—COO—C₅H₁₁ | n-pentyl acrylate | 1,300,000 |

| | Bonding | 3.5 C charging | Capacity retention | Maxiumum C-rate free |
|---|---|---|---|---|
| | force (N/m) | time (min) | rate (%) | from lithium-plating |
| Embodiment 1-3 | 14 | 46.5 | 85.5 | 4.3 C |
| Embodiment 3-1 | 14 | 46.5 | 85.5 | 4.3 C |
| Embodiment 3-2 | 14.3 | 46.4 | 85.1 | 4.2 C |
| Embodiment 3-3 | 14 | 46.5 | 85.2 | 4.1 C |
| Embodiment 3-4 | 13.9 | 47.5 | 83.2 | 4.1 C |
| Embodiment 3-5 | 14.2 | 47.2 | 84.5 | 3.9 C |
| Embodiment 3-6 | 14.1 | 46.3 | 85.4 | 4.2 C |
| Embodiment 3-7 | 14 | 47.4 | 85.0 | 4.0 C |
| Embodiment 3-8 | 14.3 | 48.5 | 83.8 | 3.9 C |

The type of the polyacrylate ester usually also affects the kinetic performance of the secondary battery. As can be seen from Embodiment 1-3 and Embodiments 3-1 to 3-5, the types of the polyacrylate ester fall within the ranges specified herein. Therefore, the charging time of the secondary battery charged at a charge rate of 3.5 C is relatively short, the capacity retention rate of the secondary battery charged and discharged for 600 cycles at a temperature of 45° C. and a C-rate of 3 C is relatively high, and the maximum C-rate free from lithium plating during persistent charging at 25° C. is relatively high, indicating that the kinetic performance of the secondary battery is superior, for example, the charging time is relatively short, the cycle performance is superior, and the lithium plating is alleviated.

The weight-average molecular weight of the negative electrode binder usually also affects the kinetic performance of the secondary battery. As can be seen from Embodiment 1-3, Embodiment 3-2, and Embodiments 3-6 to 3-8, the weight-average molecular weight of the negative electrode binder of the secondary battery falls within the range specified herein. Therefore, the charging time of the secondary battery charged at a charge rate of 3.5 C is relatively short, the capacity retention rate of the secondary battery charged and discharged for 600 cycles at a temperature of 45° C. and a C-rate of 3 C is relatively high, and the maximum C-rate free from lithium plating during persistent charging at 25° C. is relatively high, indicating that the kinetic performance of the secondary battery is superior, for example, the charging time is relatively short, the cycle performance is superior, and the lithium plating is alleviated.

TABLE 4

| | | | | Sum of thickness | | | | |
|---|---|---|---|---|---|---|---|---|
| | Thickness | Thickness | Thickness ratio | of first active | | | | Maximum |
| | of first | of second | between first | layer and | | | | C-rate |
| | active | active | active layer | thickness of | Bonding | 3.5 C | Capacity | free from |
| | layer | layer | and second | second active | force | charging | retention | lithium- |
| | (μm) | (μm) | active layer | layer (μm) | (N/m) | time (min) | rate (%) | plating |
| Embodiment 1-2 | 30 | 30 | 1:1 | 60 | 15.3 | 44.1 | 86.3 | 4.5 C |
| Embodiment 4-1 | 40 | 20 | 2:1 | 60 | 15.0 | 44.3 | 86.1 | 4.5 C |
| Embodiment 4-2 | 45 | 15 | 3:1 | 60 | 15.1 | 44.5 | 86.0 | 4.4 C |
| Embodiment 4-3 | 48 | 12 | 4:1 | 60 | 14.9 | 44.6 | 86.0 | 4.4 C |

The thickness of the first active layer, the thickness of the second active layer, the ratio of the thickness of the first active layer to the thickness of the second active layer, and the sum of the thickness of the first active layer and the thickness of the second active layer usually also affect the kinetic performance of the secondary battery. As can be seen from Embodiment 1-2 and Embodiments 4-1 to 4-3, the thickness of the first active layer, the thickness of the second active layer, the ratio of the thickness of the first active layer to the thickness of the second active layer, and the sum of the thickness of the first active layer and the thickness of the second active layer fall within the ranges specified herein. Therefore, the charging time of the secondary battery charged at a charge rate of 3.5 C is relatively short, the capacity retention rate of the secondary battery charged and discharged for 600 cycles at a temperature of 45° C. and a C-rate of 3 C is relatively high, and the maximum C-rate free from lithium plating during persistent charging at 25° C. is relatively high, indicating that the kinetic performance of the secondary battery is superior, for example, the charging time is relatively short, the cycle performance is superior, and the lithium plating is alleviated.

It is hereby noted that the relational terms such as “first” and “second” herein are merely intended to differentiate one entity from another, but do not require or imply any actual relationship or sequence between the entities. Moreover, the terms “include”, “comprise”, and any variation thereof are intended to cover a non-exclusive inclusion relationship in which an object or device that includes or comprises a series of elements not only includes such elements, but also includes other elements not expressly specified herein or inherent elements of the object or device.

Different embodiments of this application are described in a correlative manner. For the same or similar part in one embodiment, reference may be made to another embodiment. Each embodiment focuses on differences from other embodiments.

What is described above is merely exemplary embodiments of this application, but is not intended to limit this application. Any modifications, equivalent replacements, improvements, and the like made without departing from the spirit and principles of this application still fall within the protection scope of this application.

What is claimed is:

1. A secondary battery, comprising a negative electrode plate; wherein the negative electrode plate comprises a negative current collector, a first active layer, and a second active layer; the first active layer is disposed between the negative current collector and the second active layer; and
in a thermogravimetric analysis, a weight loss rate of the first active layer in a temperature range of 350° C. to 500° C. is 1.3% to 3.0%, and a weight loss rate of the second active layer in a temperature range of 350° C. to 500° C. is 0.05% to 0.65%.

2. The secondary battery according to claim 1, wherein the first active layer and the second active layer each comprise a negative electrode binder; the negative electrode binder comprises a polymer formed by emulsion polymerization of styrene, acrylate ester, and acrylic acid; and, based on a mass of the negative electrode binder, a mass percent of the styrene is 5% to 65%, a mass percent of the acrylate ester is 5% to 30%, and a mass percent of the acrylic acid is 5% to 65%.

3. The secondary battery according to claim 2, wherein, based on the mass of the negative electrode binder, a sum of the mass percentages of the styrene and the acrylate acid is 70% to 95%, and the mass percent of the acrylate ester is 5% to 30%.

4. The secondary battery according to claim 3, wherein, based on the mass of the negative electrode binder, a sum of the mass percentages of the styrene and the acrylate acid is 70% to 90%, and the mass percent of the acrylate ester is 10% to 30%.

5. The secondary battery according to claim 2, wherein a weight-average molecular weight of the negative electrode binder is 700,000 to 1,200,000.

6. The secondary battery according to claim 5, wherein the weight-average molecular weight of the negative electrode binder is 800,000 to 1,200,000.

7. The secondary battery according to claim 2, wherein a chemical formula of the acrylate ester is CH₂═CH—COO—CₙH₂ₙ₊₁, and n is 3 to 9.

8. The secondary battery according to claim 7, wherein the chemical formula of the acrylate ester is CH₂═CH—COO—CₙH₂ₙ₊₁, and n is 3 to 5.

9. The secondary battery according to claim 2, wherein, based on a mass of the second active layer, a mass percent of the negative electrode binder in the second active layer is 0.05% to 0.65%; and
based on a mass of the first active layer, a mass percent of the negative electrode binder in the first active layer is 1.3% to 3.0%.

10. The secondary battery according to claim 1, wherein a ratio of a thickness of the first active layer to a thickness of the second active layer is in a range of 1:1 to 4:1, and the thickness of the first active layer is 25 μm to 80 μm.

11. The secondary battery according to claim 7, wherein a sum of the thickness of the first active layer and the thickness of the second active layer is 50 μm to 150 μm.

12. The secondary battery according to claim 2, wherein the first active layer further comprises a first active material and a first thickener, and the second active layer further comprises a second active material and a second thickener; and
the first active material and the second active material each independently comprise at least one of graphite, hard carbon, soft carbon, silicon, a silicon-carbon compound, or a silicon-oxygen compound; and the first thickener and the second thickener each independently comprise at least one of lithium carboxymethyl cellulose or sodium carboxymethyl cellulose.

13. An electronic device comprises a secondary battery, the secondary battery comprises a negative electrode plate; wherein the negative electrode plate comprises a negative current collector, a first active layer, and a second active layer; the first active layer is disposed between the negative current collector and the second active layer; and
in a thermogravimetric analysis, a weight loss rate of the first active layer in a temperature range of 350° C. to 500° C. is 1.3% to 3.0%, and a weight loss rate of the second active layer in a temperature range of 350° C. to 500° C. is 0.05% to 0.65%.

14. The electronic device according to claim 13, wherein the first active layer and the second active layer each comprise a negative electrode binder; the negative electrode binder comprises a polymer formed by emulsion polymerization of styrene, acrylate ester, and acrylic acid; and, based on a mass of the negative electrode binder, a mass percent of the styrene is 5% to 65%, a mass percent of the acrylate ester is 5% to 30%, and a mass percent of the acrylic acid is 5% to 65%.

15. The electronic device according to claim 14, wherein, based on the mass of the negative electrode binder, a sum of the mass percentages of the styrene and the acrylate acid is 70% to 95%, and the mass percent of the acrylate ester is 5% to 30%.

16. The electronic device according to claim 15, wherein, based on the mass of the negative electrode binder, a sum of the mass percentages of the styrene and the acrylate acid is 70% to 90%, and the mass percent of the acrylate ester is 10% to 30%.

17. The electronic device according to claim 14, wherein a weight-average molecular weight of the negative electrode binder is 700,000 to 1,200,000.

18. The electronic device according to claim 17, wherein the weight-average molecular weight of the negative electrode binder is 800,000 to 1,200,000.

19. The electronic device according to claim 14, wherein a chemical formula of the acrylate ester is CH₂═CH—COO—CₙH₂ₙ₊₁, and n is 3 to 9.

20. The electronic device according to claim 19, wherein the chemical formula of the acrylate ester is CH₂═CH—COO—CₙH₂ₙ₊₁, and n is 3 to 5.
